(19) United States
(12) Patent Application Publication
(10) Pub. No.: US 2014/0051291 A1
(43) Pub. Date: Feb. 20, 2014

(54) FPC SHIELDED CONNECTOR

(71) Applicants: Michel Safir, Issy-les-Moulineaux (FR); Jean Razafiarivelo, Rambouillet (FR); Nicolas Hermeline, Luisant (FR); Jean-Francois Michel, Yermenonville (FR); Masahiro Koga, Osaka (JP)

(72) Inventors: Michel Safir, Issy-les-Moulineaux (FR); Jean Razafiarivelo, Rambouillet (FR); Nicolas Hermeline, Luisant (FR); Jean-Francois Michel, Yermenonville (FR); Masahiro Koga, Osaka (JP)

(73) Assignee: FCI Connectors Singapore PTE LTD, Singapore (SG)

(21) Appl. No.: 13/810,732

(22) PCT Filed: Jul. 19, 2011
(86) PCT No.: PCT/IB2011/001868

§ 371 Date: Jul. 3, 2013

(30) Foreign Application Priority Data
Jul. 19, 2010 (IB) PCT/IB2010/002233

(51) Int. Cl. H01R 12/61

(52) U.S. Cl. CPC H01R 12/61
USPC 439/607.35

(57) ABSTRACT

Connector (1) for flexible printed circuit (FPC) (3) comprising a connector housing (5) including an insertion slot (4) adapted to receive the FPC (3). The connector comprises a shield (18) adapted to be electrically connected to a ground path (2a) of a circuit substrate (2) on which the connector (1) is to be mounted. Said insertion slot (4) comprises a signal side corresponding to conductive tracks (29) of the FPC and a ground side (26a) opposite to said signal side. The shield comprises at least one electrically conductive tooth (25), movable from a retracted position outside the insertion slot (4), to a protruding position where said tooth (25) protrudes from the ground side (26a) to the inside of the insertion slot (4).

### FIELD OF THE INVENTION

The present invention relates to an electrical connector for connecting a Flexible Printed Circuit (FPC) or a flat cable, with a circuit substrate such as a Printed Circuit Board (PCB).

Both FPC and PCB include a large number of conductive (signal) tracks which are embedded inside the material of it. The electrical connector between FPC and PCB provides an electrical path between each conductive (signal) tracks of the FPC to a corresponding conductive (signal) track of the PCB.

Due to today's signal frequencies increase, a greater possibility exists for electrical noise to be generated in the connector environment in forms of reflections, cross-talk and electromagnetic radiation. This explains why it is important to protect this signal against Electromagnetic Interferences (called EMI) in order to prevent the outside from affecting the signal transmission. An EMI shielding is therefore provided around the connector in order to isolate the signal transmission from the outside electromagnetic field. The connector EMI shielding is electrically connected to the ground layer of the PCB and to the ground layers of the FPC so as to provide a continuity of such EMI protection. Additionally, as the flexible print circuit is a thin plastic sheet, it may be interesting to reduce the force to be applied on it for inserting it into the connector.

The application WO 2008/050184 discloses a connector for a flexible connection member. A housing with its electrical terminal is mounted on a PCB. A movable actuator applies a force on the flexible member to ensure physical contact between the set of signal tracks and the corresponding contact elements of the connector. Therefore, such a connector provides zero insertion force for the flexible member. However, it may be interesting to improve the EMI shielding protection around the connector.

U.S. Pat. No. 6,863,559 discloses an electrical connector for a shielded flexible printed circuit (FPC). The connector includes a shielding mounted on the housing of the connector. The FPC is introduced inside the housing with the tracks oriented towards the top. The connector shielding includes some grounding tabs which mate with the corresponding grounding tabs of the flexible printed circuit. Such a connector is only compatible with FPC having grounding tabs which are not protected or with FPC where the grounding metallic layer protection is previously stripped-off before the insertion of the FPC inside the connector.

The invention provides a connector for Flexible Printed Circuit (FPC) having a ground layer covered by a protective insulating layer which is readily to use while displaying signal integrity performance.

A goal of the invention is to provide a connector having both an EMI shielding and providing a zero insertion force for a shielded flexible printed circuit.

### SUMMARY OF THE INVENTION

According to one embodiment, the invention provides a connector for flexible printed circuit (FPC) according to claim 1.

Due to the retracted position, the movable teeth in such a position do not prevent the FPC from entering the insertion slot. So, the insertion of the FPC requests zero insertion force. The protruding position of the conductive tooth forces the conductive teeth to interact with the FPC. Such interaction allows electrical contact by just pressing an accessible brand tab or layer or by piercing the protection layer before contacting the ground layer of the FPC.

Thus, by providing a shielding with a conductive tooth to get into contact with the FPC ground layer, it is no more necessary to strip-off the protective layer before assembling the FPC to the connector. The connector according to the present invention is more flexible with respect to the FPC to be connected.

In some other embodiments, one might also use one or more of the features as defined in dependent claims.

### BRIEF DESCRIPTION OF THE DRAWINGS

Other characteristics and advantages of the invention will readily appear from the following description of some of its embodiments, provided as a non-limitative example, and of the accompanying drawings. On the drawings:

FIG. 1 is a perspective view of a first embodiment,

FIG. 2 is a perspective view of the first embodiment without the lid,

FIG. 3 is a perspective view of the lid and of a ground portion of the first embodiment,

FIG. 4 is a cross-section of the first embodiment, according to plan IV of FIGS. 1, 2, 3,

FIG. 5 is a longitudinal section of the FPC connected to the first embodiment, according to plan V of FIG. 6,

FIG. 6 is a cross-section of the FPC according to plan VI of FIG. 5,

FIG. 7 is a cross-section of the FPC according to plan VII of FIG. 5 showing the tolerance of the tooth extremity,

FIG. 8 is a cross-section of a second embodiment according to a second embodiment, and

FIGS. 9, 10, 11 are perspective views of the lid of a third, a fourth, and a fifth embodiments.

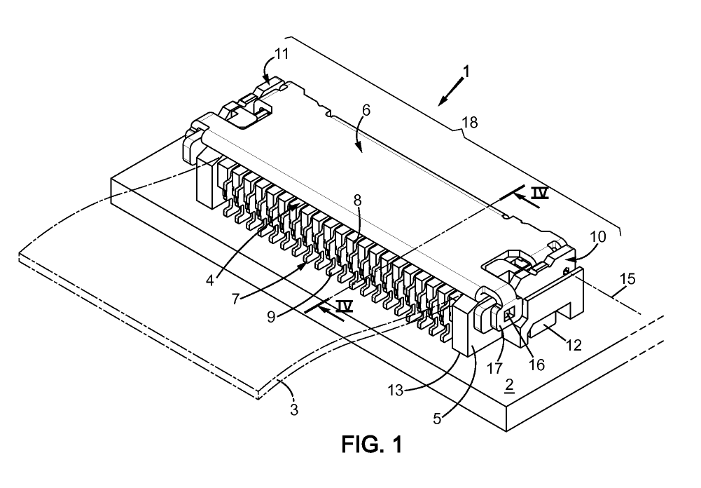

According to FIG. 1, a connector 1 is fixed and electrically connected to a rigid printed circuit board 2. A flexible printed circuit (FPC), represented by a mixed doted line, is introduced into an insertion slot 4 of the connector 1. The insertion slot 4 extends between a connector housing 5 and a top lid 6 shown in a closed position.

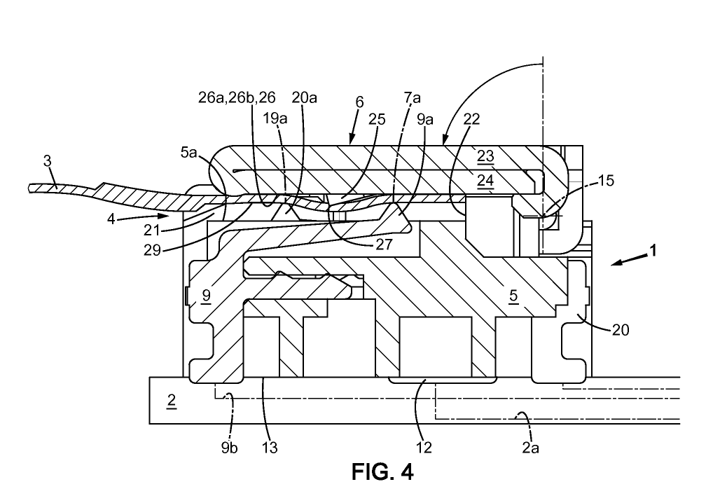

A first series 7 of electrical (signal) terminals 9 is fitted into the connector housing 5. All the electrical signal terminals 9 of that first series 7 are introduced in a corresponding groove 8 of the housing 5 from a front side of the connector 1. They are made of electrically conductive material and are attached to the housing 5 which is made of insulating synthetic material. The electrical signal terminals 9 are further adapted to be attached to the PCB in order to be electrically connected to a corresponding conductive track 9b of the PCB (visible in FIG. 4).

The front side of the connector is designated as the connector side by which is introduced the flexible printing circuit. The right and left sides of the connector are designated as the lateral sides viewed from the front side. The vertical and the horizontal direction are referred in respect with the plan of the printed circuit board on which the connector 1 is to me mounted.

The connector 1 further comprises a right ground portion 10 and a left ground portion 11. Each of the ground portions 10, 11 has a global T-shape and is made in one metallic plate. A vertical part 12 of the T-shape extends from a fixation surface 13 of the connector 1 by which the connector is to be mounted on the PCB. Both vertical parts 12 of each ground portion 10, 11 are adapted to be welded on the PCB in order to be electrically connected to a ground path 2a, which is for instance located inside the PCB (illustrated in FIG. 4).

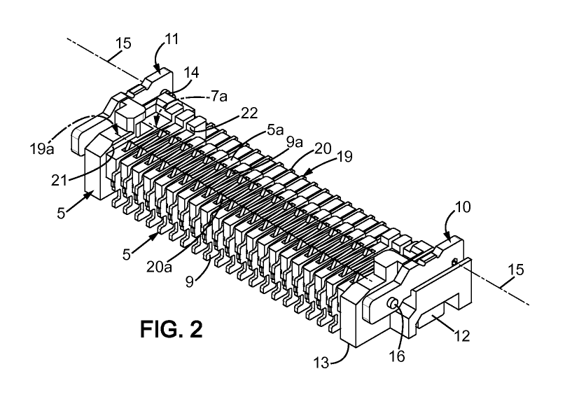

The vertical part 12 of each ground portion 10, 11 includes a rear lug 14 (visible in FIG. 2) extending horizontally from a rear side towards the inside of the connector 1. The two rear lugs 14 of each ground portion 11, 12 define a rotation axis 15 of the lid 6, perpendicular to the insertion direction of the flexible printed circuit.

The vertical part of each ground portions 10, 11 further includes a front lug 16 extending horizontally towards the outside of the connector 1. The lid 6 further comprises a right and a left front spring tongues 17 covering the corresponding ground portions 10, 11 and further extending vertically and terminated by an eyelet hole which cooperate with the corresponding front lug 16 to provide latching means. Said latching means 14-17 are adapted to maintain the lid 6 in the illustrated closed position.

Both front and rear lug 14, 16 are punched from the metallic plate of the ground portions 10, 11. The lid 6 is also made of metallic folded sheet. The electrical contact between the lid 6 and the ground portions 10, 11 is provided at least by the contact between the front spring tongues 17 and the front of the horizontal portion of the ground portions 10, 11 when the lid 6 is in the closed position. The electrical contact may also be provided by the contact between the lid 6 and the rear lug 14. Therefore, the lid 6, which extend horizontally at the top of the connector 1, together with the two ground portions 10, 11 which extend on each lateral sides, constitute all together an EMI shielding 18 which electromagnetically surrounds the signal terminals 9 of the connector 1.

As illustrated in FIG. 2, each signal terminal 9 of the first series 7 comprises a free end 9a which are all disposed along a first contact line 7a. The connector 1 further comprises a second series 19 of signal terminals 20. Each signal terminal 20 of said second series 19 is introduced in a corresponding groove 8 of the housing 5 by the rear side of the housing 5, opposite to the front side. Each signal terminal 20 comprises a free end 20a. All free ends 20a are disposed along a second contact line 19a. Each of the free ends 9a or 20a are elastically movable along the vertical direction, perpendicular to the insertion slot 4 of the flexible printed circuit and protrudes from a top surface 5a of the housing 5.

The housing 5 comprises two inner lateral sides 21 and several abutment blocks 22 for guiding the FPC during the insertion.

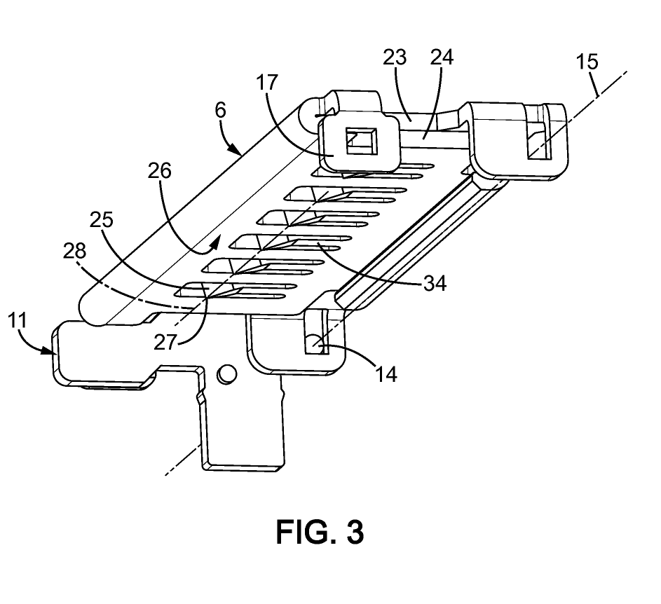

As illustrated in FIG. 3, the lid 6 comprises a top fold 23 and a bottom fold 24, folded back below the top fold 23.

A series of teeth 25 is cut out inside the bottom fold 24. The aperture provided by the teeth cuts are electromagnetically obstructed by the plan of the top fold 23.

FIG. 3 shows the rear lug 14 of the left ground portion 11 which defines the rotation axis 15 about which the lid 6 rotates.

As illustrated in FIG. 4, the insertion slot 4 is limited upwardly by the bottom surface 26 of the bottom fold 24, and is also limited laterally by the inner lateral sides 21, axially by the abutment block 22 and downwardly by the top surface 5a. The FPC is introduced in the slot 4 such that signal tracks 29 of the FPC 3 are oriented towards the free ends 9a, 20a. The bottom surface 26 of the lid 6 is therefore a ground side 26a of the insertion slot 4.

For connection of the FPC to the PCB, the connector is initially provided with the lid 6 open. The flexible printed circuit is introduced in the insertion slot 4 up to the butting block 22. Then, the lid 6 is turned down about the rotation axis 5 according to the arrow of FIG. 4. During the closing operation, the flexible printed circuit is sandwiched between the bottom surface 26 of the lid and the pressed free ends 9a or 20a. So, the bottom surface 26 of the lid is also a holding surface 26b.

Each tooth 25 protrudes from the bottom surface 26 and has a tooth extremity 27 terminated by a V edge line. Each edge line is sharp and has a cross radius of curvature smaller than 80μ, and preferably smaller than 50 μm. The tip of the V-shape is therefore a very sharp point which is suitable to injure and/or to pierce a protection polymer layer of the flexible printed circuit.

Additionally, the teeth extremities 27 are all located on a teeth line 28 (visible in FIG. 3) which is parallel to the rotation axis 15 and perpendicular to the FPC insertion direction. In the particular case of the first embodiment, the teeth line 28 is disposed between and preferably in the middle of the first and of the second contact lines 7a, 19a. As the teeth 25 protrudes from the ground side 26a of the end 6 towards the inside of the insertion slot 4, the closing of the lid 6 presses the FPC and provokes the FPC to bend in a wave shape between the two contact lines 7a, 19a.

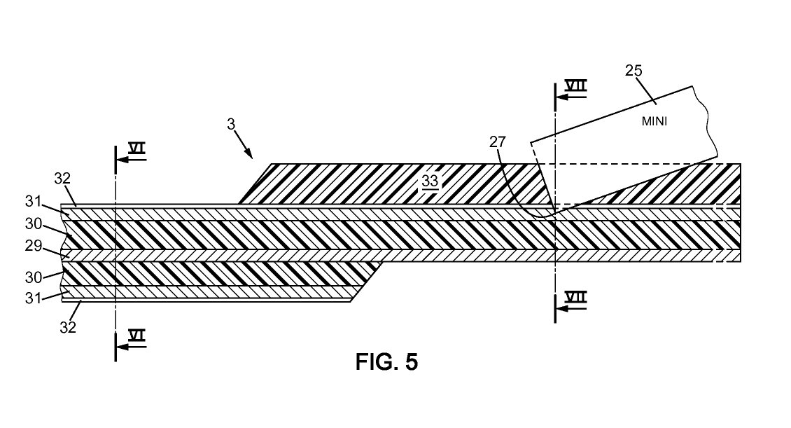

The sharp shape of the teeth 25 are such that the depth of the bite of the tooth's bite is roughly the half of the FPC thickness. The tooth's bite is deep enough for the tooth extremity 27 to reach a ground metallic layer 31 of the FPC (see FIGS. 5-7). Therefore, by closing the lid 6, the connector shielding 18 is electrically connected to the FPC ground layer 31. The connector 1 provides an EMI shielding connection together with a zero insertion force for the shielded Flexible Printed Circuit.

The vertical protrusion distance between the teeth extremity 27 and the holding surface 26b is in correlation with the horizontal distance between the two contact lines 7a-19a, in order to bend the FPC into said wave shape such that the pressure on the teeth 25 is reasonable. For example, for a distance between the contact lines 7a-19a of 800 μm, the vertical protrusion distance could be around 100 μm. Therefore, the pressure is small enough to prevent the teeth from reaching the signal tracks 29 (see FIGS. 5-7) and from piercing totally the flexible printed circuit.

As illustrated in FIGS. 5-7, the flexible printed circuit includes some metallic signal tracks 29 which extend parallelly to each other all along the FPC length and are located roughly in the middle of the FPC thickness. The signal tracks 29 are sandwiched between two insulating layers 30, the thickness of which being around 70 μm. Two ground layers 31 cover all of each side of the FPC and provide an EMI shielding to the FPC. The thickness of the metallic ground layer 31 is about 20 μm. Additionally, two corrosion polymer protection layers 32 cover the two ground layers 31. The thickness of the protection layer 32 is about 5 μm.

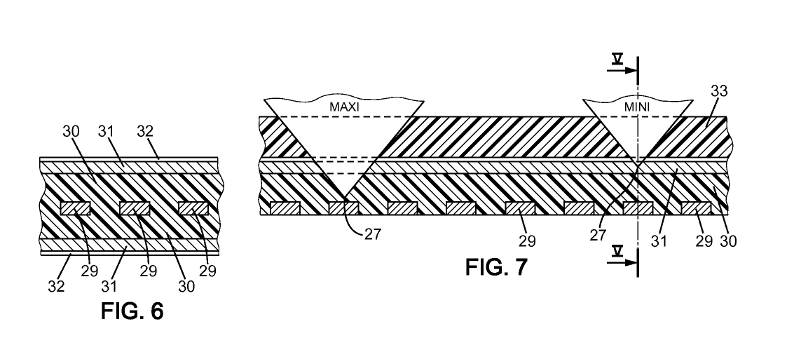

As illustrated in FIGS. 5 and 6, the extremity of the FPC to be introduced into the PCB connector 1 is strengthened and stripped. The insulating layer 30 is stripped off in one side of the FPC extremity so that the signal tracks 29 are accessible from outside. Prior to that operation, the extremity is reinforced by adding a stiffening layer 33 on the opposite side. The stiffening layer 33, also called the stiffener 33, may be a 70 μm thick polymer layer. After the above preparation, the FPC extremity presents a signal track side and a stiffener side.

As illustrated in FIG. 6, the sharpness of the tooth extremity 27 and the bending of the FPC are sufficient for the tooth extremity 27 to pierce the stiffening layer 33 and to reach the ground layer 31. This is the minimum depth for the bite of the tooth 29. However, the flexibility of the FPC and the resistance against the tooth penetration of the stiffening layer 33 are such that the tooth extremity 27 is prevented from reaching the signal tracks 29.

The inclination of the V-shape of the teeth 25 with respect to the holding surface 26b is between 10° to 40°, and preferably between 15 and 25°. For example, an inclination of 20° provides an easy penetration of the tooth extremity 27 along the first tens of micron inside the stiffening layer 33. The penetration resistance increases rapidly such that it is possible to stop the penetration before about 110 to 130 μm which is the practical maximum depth of the bite of the tooth 25.

The same connector may comprise a plurality of teeth 25. For each connector, there is an average protrusion distance of its teeth and there is a maximum dispersion of the protrusion distance between two adjacent teeth of the same connector.

To better control the depth of the bite of the teeth 25, the dispersion between two adjacent teeth 25 of the same connector is controlled to be smaller than 70 μm, preferably smaller than 50 μm, and most preferably smaller than 40 μm. This prevents a particular tooth 25 from piercing the FPC by a distance 50 μm bigger than the depth of the bite of the other tooth.

However, the variation of the average protrusion distance from one connector to another connector may vary from 100 μm to 200 μm because such variation only provokes a variation of the wave shape of the FPC between the two contact lines 7a-19a.

To improve the tooth pressure control, each tooth can be located at the extremity of the tooth spring arm 34 (see FIG. 3).

The FPC insertion slot 4 has a signal side from which the free ends 9a, 20a protrude. So, the FPC is inserted such that the stripped signal tracks 29 are oriented facing said signal side. The stiffener side of the FPC is oriented towards the opposite side of the signal side. In other words, the electrical contact between the connector shield 18 and the ground layer 31 of the FPC extremity is established through the insertion slot side which is the opposite to the signal side. This avoids any electrical contact between the ground layer 31 and one several signal tracks 29.

In an alternative embodiment, there are two movable mechanisms. A first mechanism puts the holding surface 26b in place on the ground side 26a of the insertion slot 4 after the FPC being introduced. This provides a zero insertion force for the FPC. A second mechanism puts the teeth 25 in place into the inside of the insertion slot 4 through the ground side 26a. Preferably, the first mechanism is actuated first or at least simultaneously with the second mechanism.

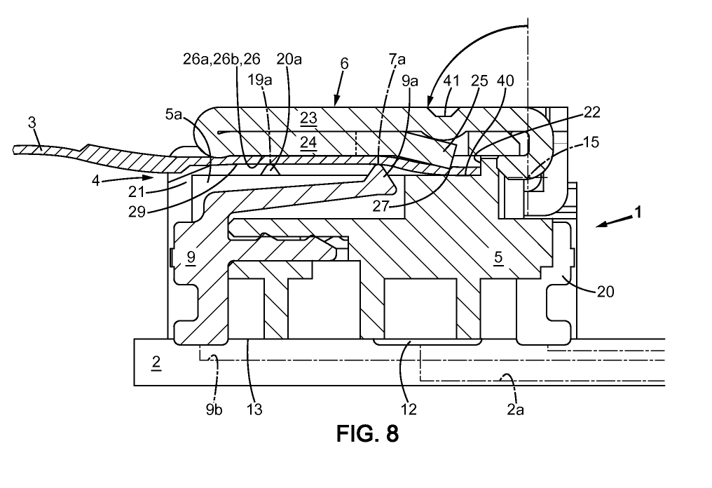

The second embodiment illustrated in FIG. 8, differs from the above first embodiment in that the tooth extremities 27 are located between the axial butting bloc 22 and the free ends 9a of the signal terminals 9. When the lid 6 is closed, the flexible printed circuit 3 is still sandwiched between the holding surface 26b and the free ends 9a, 20a. The protrusion of the conductive teeth 25 from the ground side 26a of the insertion slot 4 meet a FPC portion which is not held by the free ends 9a, 20a. The tooth extremities 27 push the FPC against a reference surface 40 of the housing 5. This reference surface 40 is located on the bottom side of the insertion slot 4 which comprises the free ends 9a, 20a.

In the second embodiment, the depth of the bite is the direct consequence of the distance of the tooth extremities 27 to the reference surface 40. Such a distance is entirely under the control of the connector manufacturer. The bending modulus of the flexible printed circuit 3, which is under the responsibility of the FPC supplier, has no impact on the depth of the bite. This simplifies the responsibility evaluation when something wrong happens in the connection.

To improve the control of the distance between the tooth extremity 27 to the reference surface 40, the tooth 25 is cut in the bottom fold 24 and is held in a fixed position by a punch 41 provided in the top fold 23.

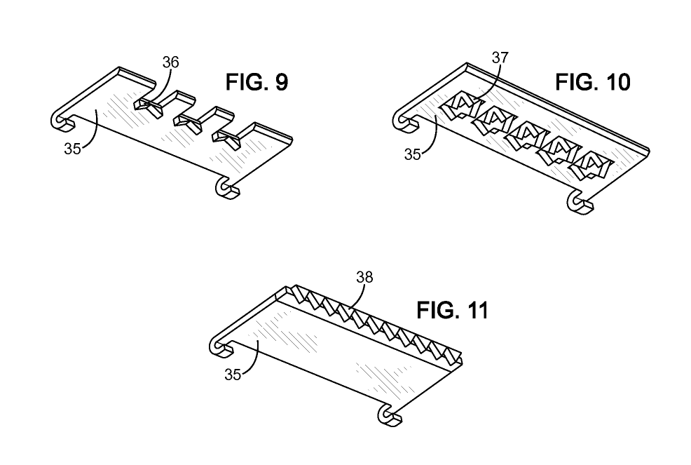

The third, the fourth, and the fifth embodiments illustrated on FIGS. 9, 10, 11 include ground teeth, rigidly attached to a lid 35. The closed position of the lid 35 may use a stop part (not shown). Each tooth has a global triangular shape, cut from a metallic sheet. The tooth extremity is obtained by the intersection of the two planes of the two cut sides. The tooth extremity is therefore a sharp segment whose length corresponds to the sheet thickness.

The teeth of the second embodiment (FIG. 8) are made by several groups of a pair of triangular teeth 36 extending in a vertical plane perpendicular to the FPC insertion direction.

The teeth of the third embodiment (FIG. 9) are made by several groups of four adjacent teeth 37 having their base along a square. Two of the four teeth have their extremity segment parallel to the FPC insertion direction and the other two teeth have their extremity segment perpendicular.

The teeth of the fourth embodiment (FIG. 10) are all adjacent along a teeth line perpendicular to the insertion direction.

A fifth embodiment, not illustrated, may be used for FPC where the used signal tracks do not cover all the width of the FPC. Therefore, the conductive tooth may pierce totally the FPC thickness through an area where the tracks were not used.

1. A connector for a flexible printed circuit (FPC) comprising:
a connector housing including an insertion slot adapted to receive the FPC; and
a shield adapted to be electrically connected to a ground path of a circuit substrate on which the connector is to be mounted, wherein the insertion slot comprises a signal side corresponding to conductive tracks of the FPC and a ground side opposite the signal side, and wherein the shield comprises at least one electrically conductive tooth movable from a retracted position outside the insertion slot to a protruding position where the tooth protrudes from the ground side into the insertion slot.

2. The connector of claim 1, further comprising a movable lid having a bottom surface, wherein the at least one tooth, in the protruding position, protrudes from the bottom surface.

3. The connector of claim 2, wherein the lid is rotatable about a rotation axis.

4. The connector of claim 2, wherein the lid and the at least one tooth form a single piece made of metal.

5. The connector of claim 2, wherein the shield comprises a ground portion which is fixed with respect to the connector housing and which extends up to a fixation surface of the connector by which the connector is to be mounted on the circuit substrate.

6. The connector of claim 5, wherein the lid and the ground portion are electrically connected when the lid is in a closed position.

7. The connector of claim 5, wherein the lid and the ground portion comprise latching means adapted to maintain the lid in a closed position at least when the bottom surface is pressed in a perpendicular direction towards the outside of the insertion slot.

8. The connector of claim 2, wherein at least one of the at least one tooth includes a tooth extremity which is configured and arranged for piercing a FPC polymer layer.

9. The connector of claim 8, wherein each of the at least one tooth extremities are at a predetermined distance from the bottom surface within a dimensional tolerance smaller than 70 mm.

10. The connector of claim 8 further comprising a plurality of teeth extremities, wherein a protrusion distance between two adjacent teeth extremities from the same bottom surface vary within a maximum dispersion smaller than 70 mm.

11. The connector of claim 8, wherein the tooth is located at an extremity of a tooth spring arm.

12. The connector of claim 8, wherein the tooth extremity includes a sharp point or line.

13. The connector of claim 12, wherein the point or line has a local radius of curvature smaller than 150 mm.

14. The connector of claim 1, further comprising a plurality of signal spring terminals located at the signal side of the insertion slot, each signal terminals comprising a free end adapted to electrically contact one conductive track of the FPC.

15. The connector of claim 14, wherein the free ends of the signal terminals are alternately distributed along two parallel contact lines, substantially perpendicular to an insertion direction of the FPC.

16. The connector of claim 15, further comprising a plurality of teeth distributed along a teeth line, substantially perpendicular to the insertion direction of the FPC.

17. The connector of claim 16, wherein the teeth line, in the protruding position, is located between the two contact lines with respect to the FPC insertion direction.

18. The connector of claim 16, wherein the teeth line is located between an inner axial butting bloc of the insertion slot and the plurality of the free ends of the signal terminals.

19. The connector of claim 1, wherein the tooth has a triangular shape, etched or punched in a metal sheet.

20. The connector of claim 19, wherein each triangular shape extends on a planar surface which is biased with respect to the insertion slot by an angle between 10° and 40° when the corresponding tooth is in its protruding position.

21. The connector of claim 19, further comprising several pairs of teeth arranged side by side, or a plurality of teeth arranged all side by side along a segment, or several groups of four teeth arranged side by side along the sides of a square.

22. The connector of claim 2, wherein the lid comprises a top fold and a bottom fold, folded back below the top fold; all of the at least one tooth being cut out inside the bottom fold, the aperture provided by the teeth cuts being electromagnetically obstructed by the top fold.

23. An assembly of a connector comprising:
a flexible printed circuit (FPC); and
a printed circuit board (PCB), wherein the FPC includes a series of signal tracks, a ground layer and a polymer layer covering, at least in the connector, a side of the ground layer opposite to the signal tracks, wherein the connector is mounted on the PCB and comprises a shield electrically connected to a ground path of the PCB, wherein the FPC is inserted into the connector such that the series of the FPC signal tracks is facing a corresponding series of connector signal terminals, and wherein the shield comprises at least one electrically conductive tooth which pierces the polymer layer and electrically connects the ground layer.

24. A method for connecting a flexible printed circuit (FPC) to a printed circuit board (PCB), the method comprising:
positioning an FPC extremity on a connector, wherein the FPC comprises an extremity with signal tracks on one side, a ground layer insulated from the signal tracks and a polymer layer protecting the ground layer on the other side of the FPC, and wherein the FPC signal tracks are directly facing a series of spring signal terminals of the connector,
pressing the FPC signal tracks against the corresponding signal terminal to electrically connect them; and
piercing the FPC polymer layer with a conductive tooth to electrically connect the FPC ground layer with a PCB ground path.

25. The method of claim 24, wherein the pressing and the piercing are simultaneous.

26. The connector of claim 8, wherein each of the at least one tooth extremities are at a predetermined distance from the bottom surface within a dimensional tolerance smaller than 50 mm.

27. The connector of claim 8 further comprising a plurality of teeth extremities, wherein a protrusion distance between two adjacent teeth extremities from the same bottom surface vary within a maximum dispersion smaller than 50 mm.

28. The connector of claim 12, wherein the point or line has a local radius of curvature smaller than 80 mm.

29. The connector of claim 12, wherein the point or line has a local radius of curvature smaller than 50 mm.

30. The connector of claim 15, wherein the free ends of two adjacent signal terminals are on different contact lines.

31. The connector of claim 19, wherein each triangular shape extends on a planar surface which is biased with respect to the insertion slot by an angle between 15° and 25°, when the corresponding tooth is in its protruding position.
